(19) United States
(12) Patent Application Publication
(10) Pub. No.: US 2008/0077622 A1
(43) Pub. Date: Mar. 27, 2008

(54) Method of and apparatus for managing data utilizing configurable policies and schedules

(76) Inventor: Robert O. Keith, Modesto, CA (US)

Correspondence Address: HAVERSTOCK & OWENS LLP, 162 N WOLFE ROAD, SUNNYVALE, CA, 94086, US

(21) Appl. No.: 11/525,471

(22) Filed: Sep. 22, 2006

(51) Int. Cl. G06F 17/30

(52) U.S. Cl. 707/200

(57) ABSTRACT

A system and method for managing data is described herein. A Data Manager (DM) is an application that is able to be situated on a server or a user system to provide capabilities of managing user data. The user data is located and knowledge of where the data is located is stored by the DM. Users are then able to set policies based on scheduling which will manage their data. Furthermore, within the data manager are utilities for managing the data efficiently and properly. The utilities include database management, open file management, VSS, synchronization and encryption. The DM uses the utilities and the policies provided and is able to manage the data as needed so as to ensure environment is healthy and managed the way the user desires.

### FIELD OF THE INVENTION

The present invention relates to the field of data management. More specifically, the present invention relates to the field of managing data utilizing a policy-based application.

### BACKGROUND OF THE INVENTION

Companies in today's environment are forced to manage extremely large amounts of data since most work is performed on computers. When employees utilize their computers every day, eventually there are going to be data management issues, such as where does which data go and when does that data go there. Usually all of the data will not fit on a single user hard drive, furthermore for accessibility and security purposes, it is not best to set up a system in such a way. Thus, computer managers must perform many managerial tasks to ensure data is stored efficiently and properly. For example, data that is utilized often is preferably in a location where it is quickly accessible. Contrarily, data that is rarely used should be located in storage which is accessible, but not necessarily quickly.

There are many ways of managing data including deleting, copying, archiving and backing it up amongst others. Through simple commands such as the text command “del” in MS-DOS, click+delete in Windows and “rm” in Unix, users are able to delete data. Copying is similarly performed with its specific commands. With copying, users are able to copy data to different locations on the same hard drive, other drives or even other devices. Furthermore, copying is a simple tool for backing up data. For example, if data is initially stored on a user's hard drive, copying it to a second hard drive is a way of backing up data since if the first hard drive fails, that will not affect access to the second hard drive. However, if the computer is destroyed, both hard drives would be lost and so would the data. Hence, other forms of backup are possible which enable the data to be stored away from the original hard drive data, such as copying the data to a floppy disk, CD or DVD. These removable media have the downside of being limited in capacity. Furthermore, there are problems of keeping track of each media and having to continuously swap disks in and out as they become full. To overcome those issues, network drives are available which couple to the device across a network. These network drives are able to be located at different ends of the world to ensure something like a fire, hurricane, flood or other natural disaster, in one location does not destroy the data in the other locations.

Furthermore, network storage techniques like Redundant Array of Inexpensive Disks (RAID), Storage Area Networks (SAN) and Network Attached Storage (NAS) enable continuous growth of the storage. Thus, with advancements of networking and the Internet, data protection is relatively stable. However, since more and more information is being stored on computers, the amount of data needed to be managed continues to grow. As the amount of data grows, the amount of time spent on managing that data also has grown. There have been developments to attempt to deal with these concerns.

@Backup®, as referenced at the webpage, http://www.backup.com/learnmore_intro.html, discloses a system for backing up data to secure data centers using the Internet. @Backup® also is able to utilize a backup schedule to determine when backing up should occur. Furthermore, for security purposes @Backup® is able to encrypt data while transferring it over the network as well as when it is stored.

U.S. Patent App. No. 2006/0095705 to Wichelman et al. discloses a data storage manager which is provided application specific information to support optimal allocation of application data storage, which includes both storage directly coupled to a single computing device and network-attached storage, relocation of existing data, and applying data management services such as backup, restore, mirroring, virus detection and isolation to the stored data. The data storage manager is also configured to assist administrators in managing capacity utilization.

U.S. Pat. No. 5,659,743 to Adams et al. discloses a pattern based space management apparatus for and method of a computer system having multiple levels of hierarchical storage comprised of code for creating and maintaining a database containing size information and historical information about the use of data sets residing on the computer system. The system calculates a next reference date for certain of the data sets and a confidence level for each of the next reference dates from information in the database. The system also identifies which data sets should be migrated between the storage levels of the computer system based on the next reference dates, the confidence levels, the sizes of the data sets, and the amount of highest level storage space which is to remain available. The system then begins the migration of the data sets identified for migration.

### SUMMARY OF THE INVENTION

A system and method for managing data is described herein. A Data Manager (DM) is an application that is able to be situated on a server or a user system to provide capabilities of managing user data. The user data is located and knowledge of where the data is located is stored by the DM. Users are then able to set policies based on scheduling which will manage their data. Furthermore, within the data manager are utilities for managing the data efficiently and properly. The utilities include database management, open file management, VSS, synchronization and encryption. The DM uses the utilities and the policies provided and is able to manage the data as needed so as to ensure environment is healthy and managed the way the user desires.

In one aspect, a system for managing data comprises a set of utilities for managing and synchronizing the data and one or more configurable policies for determining how and when to execute the set of utilities. The system further comprises a graphical user interface for receiving input from a user. The one or more configurable policies permit selecting of one or more selectable options. The selectable options are selected from the group consisting of name, type, size, last accessed, action, when, how often and where. The action is selected from the group consisting of back up, archive, delete and copy. The set of utilities further include database management and encryption. The system is stored on a server. Alternatively, the system is stored on a user computer. The data comprises user data. Data knowledge is stored and utilized by the one or more policies. The data knowledge includes locations of the data. The system runs in the background of a computer. The one or more configurable pol icies are configured by a user.

In another aspect, a system for managing data comprises a set of utilities for providing database management, synchronization and encryption, one or more configurable policies for determining how to execute the set of utilities and one or more configurable schedules for determining when to execute the one or more policies. The system further comprises a graphical user interface for receiving input from a user. The system further comprises one or more selectable options within the one or more policies wherein at least one of the options is selected.

The selectable options are selected from the group consisting of name, type, size, last accessed, action, when, how often and where. The action is selected from the group consisting of back up, archive, delete and copy. The system is stored on a server. Alternatively, the system is stored on a user computer. The data comprises user data. Data knowledge is stored and utilized by the one or more policies. The data knowledge includes locations of the data. The system runs in the background of a computer. The one or more configurable policies and the one or more configurable schedules are configured by a user.

In another aspect, a system for managing user data comprises a graphical user interface for permitting user interaction, a set of utilities coupled to the graphical user interface for providing database management, synchronization and encryption, wherein the set of utilities perform one or more actions, one or more configurable policies for determining how to execute the set of utilities, wherein the set of utilities further comprise one or more selectable options and further wherein the policies utilize user data knowledge to locate the user data, further wherein the one or more configurable policies are configured utilizing the graphical user interface and one or more configurable schedules for determining when to execute the one or more policies, further wherein the one or more configurable schedules are configured utilizing the graphical user interface. The selectable options are selected from the group consisting of name, type, size, last accessed, when, how often and where. The one or more actions are selected from the group consisting of back up, archive, delete and copy. The system is stored on a server. Alternatively, the system is stored on a user computer. The system runs in the background of a computer. The one or more configurable policies and the one or more configurable schedules are configured by a user.

In yet another aspect, a method of managing data comprises storing information related to user data and implementing a set of data management utilities for managing and synchronizing the data based on one or more user-configurable policies using the information related to user data. A graphical user interface receives input from a user for generating and configuring the one or more policies. The method further comprises generating the one or more policies. One or more selectable options within the one or more policies are used to configure the one or more policies. The selectable options are selected from the group consisting of name, type, size, last accessed, action, when, how often and where. The action is selected from the group consisting of back up, archive, delete and copy. The set of data management utilities include database management and encryption. The method is implemented on a server. Alternatively, the method is implemented on a user computer. The information related to the user data includes locations of the user data. The method runs in the background of a computer.

In another aspect, a method of managing data comprises storing information related to locations of user data, generating one or more configurable policies, implementing a set of data management utilities based on the one or more policies, wherein the data management utilities include database management, synchronization and encryption. A graphical user interface receives input from a user for generating and configuring the one or more policies. One or more selectable options within the one or more policies are used to configure the one or more policies. The selectable options are from the group consisting of name, type, size, last accessed, action, when, how often and where. The action is from the group consisting of back up, archive, delete and copy. The method is implemented on a server. Alternatively, the method is implemented on a user computer. The method runs in the background of a computer. The one or more configurable policies are configured by a user.

### BRIEF DESCRIPTION OF THE DRAWINGS

FIG. 1 illustrates a block diagram of the Data Manager, data sources and other managers of an embodiment of the present invention.

FIG. 2 illustrates an exemplary Graphical User Interface of an embodiment of the present invention.

FIG. 3 illustrates a flowchart of utilizing the Data Manager.

FIG. 4 illustrates a flowchart of an exemplary implementation of the Data Manager.

### DETAILED DESCRIPTION OF THE PREFERRED EMBODIMENT

A system and method for managing data is described herein. A Data Manager (DM) is an application that is able to be situated either on a server or a user computer system to provide capabilities of managing user data. The DM functions by locating user data and storing that knowledge of where the data is located. Preferably, only user data information is acquired and not applications or application software. It is recognized that applications are generally much larger and do not change as often as user data does, so applications do not need to be dealt with the same way user data does. Furthermore, applications are typically stored at a central location already and distributed to user computers, so there is no need to back them up again.

With the DM, a user is able to configure policies and schedules to manage the data. A Graphical User Interface (GUI) is provided for easy user interaction and to permit the user to generate, modify and remove the policies and schedules. The GUI permits non-computer savvy users to configure policies and schedules. Additionally, the DM is able to run in the background of the user computer or server to continuously monitor the system. Options within the policies and schedules include, but are not limited to determining actions to take with the data and when to take those actions. The actions taken include but are not limited to backing up the data, copying the data from one system to another, archiving the data, storing the data in a briefcase on the Internet and storing it on a network drive. Other information is needed for some actions, such as when archiving the data, determining where it is to be archived. In addition to being able to configure a policy as desired, a user is able to have multiple policies. Based on the policies designated, the DM also determines how accessible data is such as whether it is stored locally or archived.

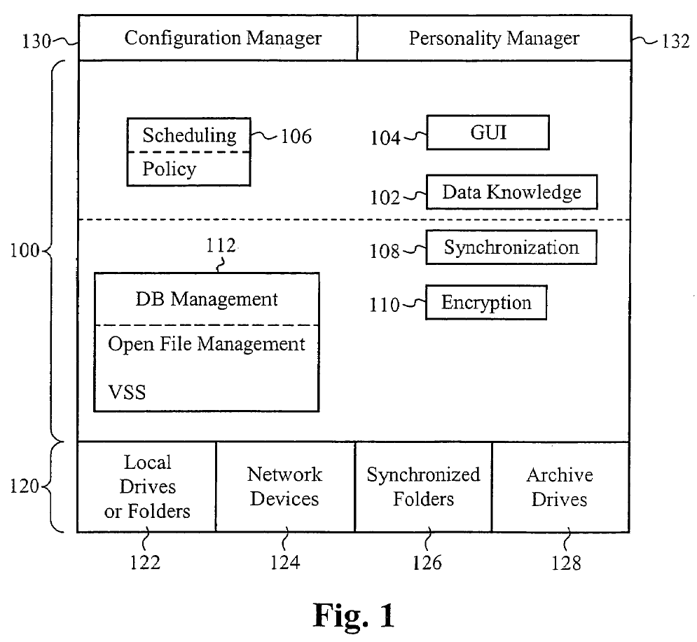

FIG. 1 illustrates a block diagram of a DM 100, data sources 120 and other managers including configuration manager 130 and personality manager 132. The DM 100 comprises data knowledge 102, a Graphical User Interface (GUI) 104, a schedule/policy generator 102, and a number of utilities for managing data. The configuration manager 130 remembers which configurable components are to remain with the current system and which are portable as a user moves from device to device. For example, file locations, directory structures, application configurations, color schemes and favorites are able to travel with a user as he logs into his account with different devices. The configuration manger 130 also is device-aware, so that when a user switches from a device such as a personal computer to device such as a PDA, the configuration manager is able to make the proper conversions, so that the second device represents the data similarly to the first device. The personality manger 132 learns a users needs, wants, and desires. For example, the personality manager 132 is installed in a user's car's computing system. The computing system is also enabled to locate the nearest points of interest such as gas stations. If a user indicates he does not buy gas at Exxon stations for personal reasons, the personality manager 132 is able to remember that, so when gas stations are listed, Exxon will not be displayed.

The data knowledge 102 includes information regarding the user data that the DM 100 retrieves from the computer system. As users use the computer system, any additional data stored on the computer system is located by the DM 100, and that knowledge is then stored in the data knowledge 102. In some embodiments, the DM 100 continuously monitors, while in the background, for any user data files saved onto the system. In other embodiments, the DM 100 runs a search periodically to determine if any new data files exist.

The schedule/policy generator 106 allows a user to schedule when policies are to be implemented and what the policies include. In the preferred embodiment, the schedule and policy generators are the same component, but in other embodiments they are separate components yet they function together. When scheduling, a user is able to designate dates/times for events to occur. The scheduling is able to be extremely specific or very general. For example, a user is able to designate Thanksgiving Day as the day to back up all of the data and remove any unnecessary data in preparation for the rush of Black Friday, the day after Thanksgiving and for the Christmas rush through December 25th. If a user desires a more generic schedule, the user is able to specify data management to occur every night at midnight since that is generally the time when the least amount of activity is going on. Furthermore, a mixture of specific and generic schedules are possible as well, so daily routines are performed and event specific management occurs as well.

A user is able to designate policies wherein certain data management actions occur at the scheduled times. Initially, the DM has default policy settings of what actions to take and when. Using the GUI 104, a user is able to modify the timing and actions taken. The actions include, but are not limited to, backing up, archiving and deleting data. The user is also able to set policies based on characteristics of the data where such characteristics include, for example, name, type, size and last modified/accessed.

In one example, where a user desires to back up his work data often because it is critically important, he is able to set a policy and schedule that performs a back up every hour.

Furthermore, not all of the user's data is backed up, but only those critical files. Thus, for a user whose work is performed with Microsoft Word, all .doc files are backed up every hour. The same user also has music files, such as .mp3 files, stored locally which change as he downloads new songs. However, since those files are not as important, they are only backed up once per day at midnight so as to avoid interrupting the system while the user is working. If the user desires to archive the music files and remove them from his local system instead of backing them up, he is able to specify that as well.

A network administrator is also able to utilize the policies and schedules on a server. In another example, a network administrator has been asked by the company's president to help resolve an ongoing problem of employees using their work computers to download and store music and movie files, the most common of which have .mp3, .mpeg, mpg, .avi, .mov and .rm extensions. The network administrator is able to access the company's server where the DM has been installed. The network administrator is then able to generate a policy with the DM where every night any files of the specified types are located on the user computers coupled to the server, and the files are deleted. In some embodiments, after the DM is installed on a server, it not only gathers information and functions on that server but also any device coupled to that server.

The utilities for managing the user data include synchronization 108, encryption 110 and database management 112. Additionally, other utilities are able to be included as well. The synchronization utility 108 ensures that data is synchronized when it is copied to a different location. If desired, data is able to be encrypted by the encryption utility 110 as it is being transferred. For example, if a user wants to back up personal data on a network drive where the personal data includes credit card numbers and addresses, he does not want others to be able to steal that data while it travels over the network. The encryption utility 110 allows a secure transmission. Furthermore, if the user desires to keep the data encrypted while on the network drive so as to prevent a hacker from stealing the data if the drive is ever compromised, that is possible as well.

The database management utility 112 is able to understand what databases are and what type they are such as Microsoft® Access or Sequel. The database management utility 112 then uses a facility like open file management to handle the fact that the database is open, live and in transit. Volume Shadow copy Service (VSS) is also used to take snapshots of the file system. Other tools within the database management utility 112 are also available to ensure correct and efficient copying or other manipulations of the database.

The data sources 120 where the data is managed include, but are not limited to, local drives 122, network devices 124, synchronized folders 126 and archive drives 128. The local drives 122 are the standard computer hard drives containing the local file system. The local drives 122 are the fastest access to data generally since it is closest in proximity, in addition to the fact that retrieving data from a hard drive is generally faster than over a network or other attached drive. The network devices 124 are similar to other devices but they are accessed across a network. Depending on the speed of the network, retrieving data from the network devices 124 is relatively fast. The synchronized folders are mirrored copies of a local folder on a server which are then accessible by other computers coupled to that server. One example of such a technology is Novell's iFolder®. The archive drives 128 are drives where data that is accessed very rarely is stored. These drives generally have slow access times as they are built to store large amounts of data, but not necessarily provide access to it quickly.

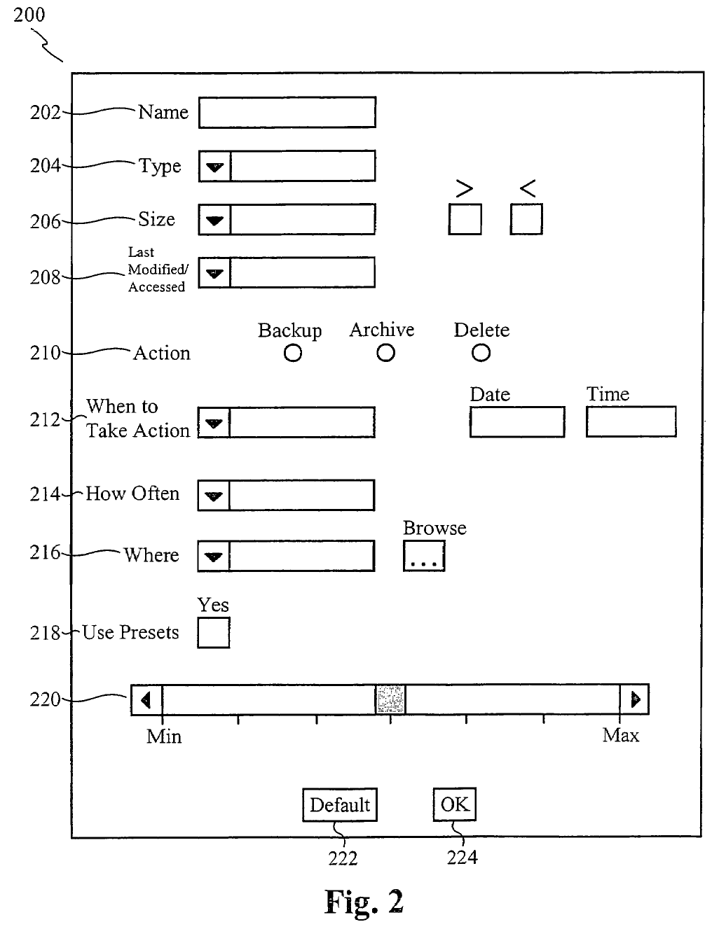

FIG. 2 illustrates an exemplary GUI 200 for interacting with the policy and scheduler. Using the GUI 200, a user has numerous options of how to configure the policy and schedule for data management. The options are able to be selected individually or together to specify a strict or broad policy. A “name” text box 202 allows a user to specify by name which data is included in the policy. The “name” text box 202 is useful if a user has been implementing a naming scheme for disparate types of files. For example, an engineer has been working on a project related to a new car radio design which utilizes wi-fi in addition to other features. The engineer has documentation written in Word, Powerpoint presentation files, drawings created using a photo editor and all of the software files for the project. Since these files have different types such as .doc, .ppt. jpg, .c and .h, a policy based on file type would require more work than a name search such as “radio” assuming all of the files have that as part of the name. If on the other hand, a policy is needed to handle a specific type of file, such as all music files, then a “type” drop-down menu 204 is able to be used. Furthermore, typical drop-down menu rules apply so that multiple items are able to be selected with the proper key strokes. Hence, a user is able to select .mp3 and .wav, and all data files with those extensions are included in the policy. A user is also able to use a “size” drop-down menu 206 to specify that all files of a certain size are included within the policy. Coupled with greater than and less than check boxes, the policy is able to focus on only data files that fit the size requirements. For example, if a user only wants files that are larger than 5 MB to be archived, the user is able to specify that by making the appropriate selections. Another feature that is able to be utilized for the policy is when the data was last modified/accessed using the drop-down menu 208. For example, a user is able to specify that data which has not been accessed for over 3 months is sent to an archive. Furthermore, a text box is able to be used instead of the drop-down menu 208 to specify an exact date.

A set of action radio buttons 210 are available to select which action the policy should take. As described above, a user is able to choose to have files that have not been accessed for a period of time archived. The user could alternatively choose to delete those files instead. Other actions include storing the data in a briefcase on the Internet or copying it to a network drive. A “when to take action” drop-down menu 212 allows a user to select when the policy should be implemented. Additional text boxes are able to be used to specify an exact date and time. For example, to avoid using system resources at peak hours, a user sets the policy to back up data at midnight. In addition to when actions are taken, how often is another option selectable by the user. A “how often” drop-down menu 214 provides users with options including once, daily, weekly, monthly and similar variations. So if a user only wants data to be backed up once a week, he is able to designate that option. A “where” text box and browse button 216 are available for a user to specify where the data is being sent. In some embodiments of the present invention, the data is sent to locations based on the action to be taken, for example all archived data is sent to drive X. However, to provide more flexibility, a user is able to designate or browse for a proper location for the data.

Another feature for making the interface simpler for users is a preset check box 218 and scroll bar 220 for selecting preset policies. The presets are able to vary greatly, but an example of presets include a minimum back up, a maximum back up and levels in between. The minimum backup only backs up essential files, for instance, all .doc files that have been accessed within a week and does it only monthly at midnight. The maximum backup backs up all user data files and does it daily at midnight.

A default button 222 resets the user's settings and sets the fields to default settings that are predetermined. An OK button 224 is used to accept the user-defined policy and to initiate it, so that when the policy is supposed to function it is able to do so.

The exemplary GUI 200 of FIG. 2 is not meant to limit the present invention in any way. Furthermore, it should be understood that although specific objects such as drop-down menus are used within the example, alternative embodiments include variations of similarly functioning objects. For example, instead of using a drop-down menu for selecting “how often” an action is taken, a set of check boxes is able to be used.

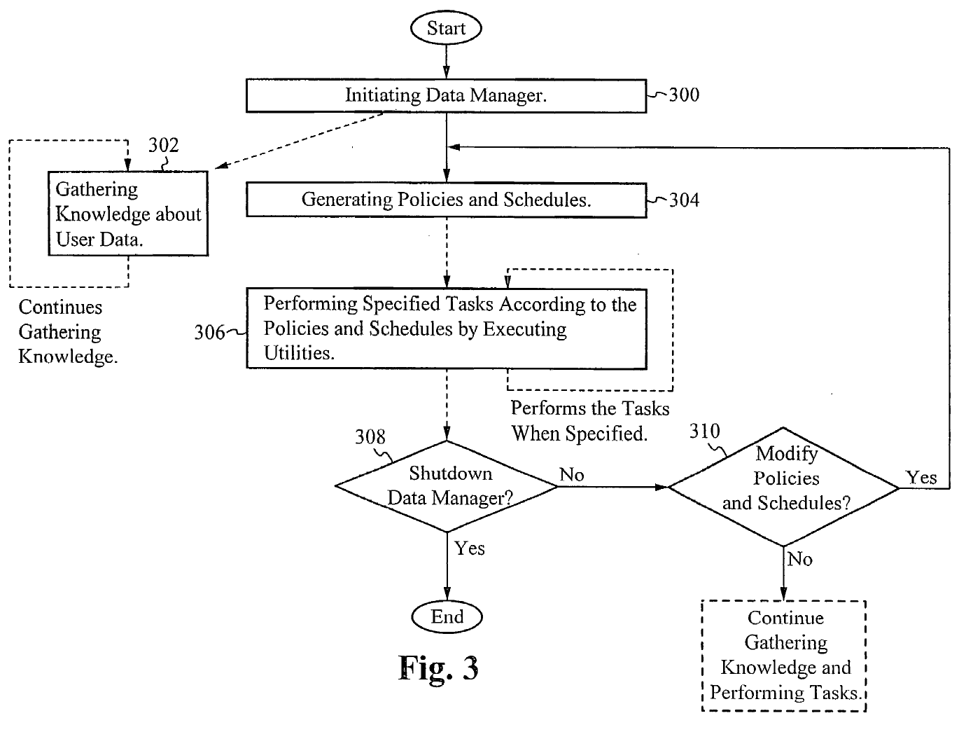

FIG. 3 illustrates a flowchart of utilizing the DM. To utilize the present invention, after the DM is installed, the DM is initiated on a user computer or a server in the step 300. Once installed, the DM runs in the background and gathers knowledge about the user data including where the data is located, the file names, types, sizes and modified/accessed dates, in the step 302. The DM continues to gather knowledge until it is shut down, so that any modifications to the user data on the system are collected. In the step 304, a user generates one or more policies and schedules to manage the data. The user is also able to add, delete or modify the one or more policies and schedules within the step 304. With the policies and schedules, the user is able to designate when and what actions are to be taken. After the policies and schedules have been generated, the DM continues to run in the background and performs the specified tasks as scheduled, in the step 306. Users are able to further modify, add or delete policies and schedules to ensure the system functions efficiently and securely. The process continues unless the DM is shutdown in the step 308. If the DM is not shut down, further knowledge is gathered and utilities are executed as defined in the policies. In the step 310, if a user desires to modify a policy or schedule, he is able to do so.

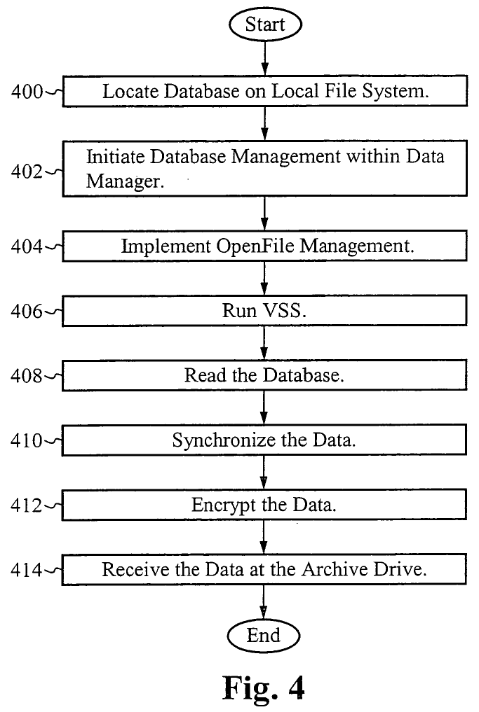

FIG. 4 illustrates a flowchart of an exemplary implementation of the DM. In this example, a policy has been defined to archive a specified database. In the step 400, the database is located, and its location is stored within the data knowledge. Then in the step 402, database management within the DM is initiated. The database management implements both the OpenFile Management and VSS in the steps 404 and 406 to ensure the database is copied correctly. In the step 408, the data within the database is read, and then the data is synchronized in the step 410. The data is also encrypted in the step 412. The data is received at the archive drive where it is stored in the step 414. The example above is not meant to limit the invention in any way. Furthermore, the steps described above are able to be added, removed or modified as desired.

In operation, the DM provides a user with a GUI with numerous options to configure a policy and schedule within the DM as desired. Some of the options include the name of the file, the type of file, the size of the file, the date the file was last modified/accessed, the action to take, when to take the action, how often and where to take the action. Additionally, a user is able to specify an exact file, folder or drive to perform operations on, if desired. Furthermore, the user is able to make multiple selections in each category such as selecting music files—.mp3 and .wav. Multiple policies are able to be generated also, so that different levels of management are implemented. After the one or more policies are generated by the user using the GUI, one or more utilities implement the policies. The utilities provide database management, synchronization and encryption in addition to other desired functions. By using the DM, numerous operations are able to be automatically performed by being scheduled for execution.

The uses of the DM include, but are not limited to, backing up mission critical data from local hard drives to a storage location, synchronizing local data with a network device to allow others to access the data, archiving large data files that are not regularly used and copying multimedia files to Internet locations for sharing with others.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system for managing data comprising:
a. a set of utilities for managing and synchronizing the data; and
b. one or more configurable policies for determining how and when to execute the set of utilities.

2. The system as claimed in claim 1 further comprising a graphical user interface for receiving input from a user.

3. The system as claimed in claim 1 wherein the one or more configurable policies permit selecting of one or more selectable options.

4. The system as claimed in claim 3 wherein the selectable options are selected from the group consisting of name, type, size, last accessed, action, when, how often and where.

5. The system as claimed in claim 4 wherein the action is selected from the group consisting of back up, archive, delete and copy.

6. The system as claimed in claim 1 wherein the set of utilities further include database management and encryption.

7. The system as claimed in claim 1 wherein the system is stored on a server.

8. The system as claimed in claim 1 wherein the system is stored on a user computer.

9. The system as claimed in claim 1 wherein the data comprises user data.

10. The system as claimed in claim 1 wherein data knowledge is stored and utilized by the one or more policies.

11. The system as claimed in claim 10 wherein the data knowledge includes locations of the data.

12. The system as claimed in claim 1 wherein the system runs in the background of a computer.

13. The system as claimed in claim 1 wherein the one or more configurable policies are configured by a user.

14. A system for managing data comprising:
a. a set of utilities for providing:
i. database management;
ii. synchronization; and
iii. encryption;
b. one or more configurable policies for determining how to execute the set of utilities; and
c. one or more configurable schedules for determining when to execute the one or more policies.

15. The system as claimed in claim 14 further comprising a graphical user interface for receiving input from a user.

16. The system as claimed in claim 14 further comprising one or more selectable options within the one or more policies wherein at least one of the options is selected.

17. The system as claimed in claim 16 wherein the selectable options are selected from the group consisting of name, type, size, last accessed, action, when, how often and where.

18. The system as claimed in claim 17 wherein the action is selected from the group consisting of back up, archive, delete and copy.

19. The system as claimed in claim 14 wherein the system is stored on a server.

20. The system as claimed in claim 14 wherein the system is stored on a user computer.

21. The system as claimed in claim 14 wherein the data comprises user data.

22. The system as claimed in claim 14 wherein data knowledge is stored and utilized by the one or more policies.

23. The system as claimed in claim 22 wherein the data knowledge includes locations of the data.

24. The system as claimed in claim 14 wherein the system runs in the background of a computer.

25. The system as claimed in claim 14 wherein the one or more configurable policies and the one or more configurable schedules are configured by a user.

26. A system for managing user data comprising:
a. a graphical user interface for permitting user interaction;
b. a set of utilities coupled to the graphical user interface for providing:
i. database management;
ii. synchronization; and
iii. encryption,
wherein the set of utilities perform one or more actions;
c. one or more configurable policies for determining how to execute the set of utilities, wherein the set of utilities further comprise one or more selectable options and further wherein the policies utilize user data knowledge to locate the user data, further wherein the one or more configurable policies are configured utilizing the graphical user interface; and
d. one or more configurable schedules for determining when to execute the one or more policies, further wherein the one or more configurable schedules are configured utilizing the graphical user interface.

27. The system as claimed in claim 26 wherein the selectable options are selected from the group consisting of name, type, size, last accessed, when, how often and where.

28. The system as claimed in claim 26 wherein the one or more actions are selected from the group consisting of back up, archive, delete and copy.

29. The system as claimed in claim 26 wherein the system is stored on a server.

30. The system as claimed in claim 26 wherein the system is stored on a user computer.

31. The system as claimed in claim 26 wherein the system runs in the background of a computer.

32. The system as claimed in claim 26 wherein the one or more configurable policies and the one or more configurable schedules are configured by a user.

33. A method of managing data comprising:
a. storing information related to user data; and
b. implementing a set of data management utilities for managing and synchronizing the data based on one or more user-configurable policies using the information related to user data.

34. The method as claimed in claim 33 wherein a graphical user interface receives input from a user for generating and configuring the one or more policies.

35. The method as claimed in claim 33 further comprising generating the one or more policies.

36. The method as claimed in claim 33 wherein one or more selectable options within the one or more policies are used to configure the one or more policies.

37. The method as claimed in claim 36 wherein the selectable options are selected from the group consisting of name, type, size, last accessed, action, when, how often and where.

38. The method as claimed in claim 37 wherein the action is selected from the group consisting of back up, archive, delete and copy.

39. The method as claimed in claim 33 wherein the set of data management utilities include database management and encryption.

40. The method as claimed in claim 33 wherein the method is implemented on a server.

41. The method as claimed in claim 33 wherein the method is implemented on a user computer.

42. The method as claimed in claim 41 wherein the information related to the user data includes locations of the user data.

43. The method as claimed in claim 33 wherein the method runs in the background of a computer.

44. A method of managing data comprising:
a. storing information related to locations of user data;
b. generating one or more configurable policies;
c. implementing a set of data management utilities based on the one or more policies, wherein the data management utilities include:
i. database management;
ii. synchronization; and
iii. encryption.

45. The method as claimed in claim 44 wherein a graphical user interface receives input from a user for generating and configuring the one or more policies.

46. The method as claimed in claim 44 wherein one or more selectable options within the one or more policies are used to configure the one or more policies.

47. The method as claimed in claim 46 wherein the selectable options are selected from the group consisting of name, type, size, last accessed, action, when, how often and where.

48. The method as claimed in claim 47 wherein the action is selected from the group consisting of back up, archive, delete and copy.

49. The method as claimed in claim 44 wherein the method is implemented on a server.

50. The method as claimed in claim 44 wherein the method is implemented on a user computer.

51. The method as claimed in claim 44 wherein the method runs in the background of a computer.

52. The method as claimed in claim 44 wherein the one or more configurable policies are configured by a user.
